(19) United States
(12) Patent Application Publication
(10) Pub. No.: US 2016/0212494 A1
(43) Pub. Date: Jul. 21, 2016

(54) VIDEO RECOMMENDATION METHOD AND DEVICE

(71) Applicant: BEIJING QIHOO TECHNOLOGY COMPANY LIMITED, Beijing (CN)

(72) Inventors: Hao YANG, Beijing (CN); Kai WU, Beijing (CN)

(21) Appl. No.: 14/916,931

(22) PCT Filed: Sep. 5, 2014
(86) PCT No.: PCT/CN2014/086071

§ 371 Date: Mar. 4, 2016

(30) Foreign Application Priority Data
Sep. 6, 2013 (CN) 201310404269.1

(51) Int. Cl. H04N 21/482; H04N 21/45; H04N 21/466

(52) U.S. Cl. CPC H04N 21/4826; H04N 21/4668; H04N 21/4532

(57) ABSTRACT

Disclosed are video recommendation method and device, including: obtaining an initial user preference parameter and multiple to-be-recommended videos according to recorded history information of user-watched videos, and taking the to-be-recommended videos as current to-be-recommended videos; selecting a first to-be-recommended video in the current to-be-recommended videos and writing it into a recommendation list; calculating and obtaining user preference satisfaction degree; revising the user preference parameter according to the user preference satisfaction degree, and reordering other to-be-recommended videos not written into the recommendation list; taking the other to-be-recommended videos after reordered as the current to-be-recommended videos, returning and continuing to execute the step of selecting the first to-be-recommended video in the current to-be-recommended videos and writing the first to-be-recommended video into the recommendation list, until all the to-be-recommended videos are written into the recommendation list; recommending the to-be-recommended videos in the recommendation list to a user.

### CROSS-REFERENCE TO RELATED APPLICATIONS

This application is a national stage of International Application No. PCT/CN2014/086071, filed Sep. 5, 2014, which is based upon and claims priority to Chinese Patent Applications No. CN201310404269.1, filed Sep. 6, 2013, the entire contents of all of which are incorporated herein by reference.

### FIELD OF TECHNOLOGY

The present invention relates to the field of internet technologies and, more particularly, to a video recommendation method and device.

### BACKGROUND

Video recommendation is a method and device for video websites to help users find and watch videos in a particular area. Compared with traditional ways of browsing video directories or traditional ways of searching videos, video recommendation may recommend videos in the special area which is found needed by users after analyzing the user history behavior under the circumstance that the user cannot determine appropriate searching terms, thus avoiding the process of inputting search terms and multiple clicks on hierarchical directories, making it more simple and easy to find and watch a particular type of videos.

There are mainly two kinds of existing video recommendation technologies: collaborative filtering recommendation technology based on videos (VIDEO) and collaborative filtering recommendation technology based on users (COOKIE). The former recommends most similar videos to the videos in viewing records to the user by calculating similarity degree between videos. The latter calculates similarity degree of users based on viewing records and recommends videos which are watched by similar users to the user. Both methods are models based on the interests of the users, in which the similarity degree between candidate videos and users' interests is calculated and N most similar videos are recommended to the users.

The typical problem of the above video recommendation technologies is the singleness problem of recommendation. On the first recommendation, a video site analyzes a user's preference based on the user's viewing history and recommends the user's favorite videos according to the user's preferences. Since the user has not clicked and watched videos which satisfy his or her own preferences yet, he or she may accept the recommended videos in larger extent. But when the video site recommends constantly, the user has already clicked videos which meet his or her preferences, and the user's preferences are satisfied to a certain extent, therefore, the strength of preference demand has been changed. At that moment, the video website still recommend videos according to the user's initial preferences, which will fail to meet the user's latest demands for recommendations and lead to lose users.

### SUMMARY

In light of the above problems, the present invention provides a video recommendation method and corresponding video recommendation device which at least partially solve the above problems.

According to an aspect of the invention, there is provided a video recommendation method, comprising: obtaining an initial user preference parameter and multiple to-be-recommended videos sorted by recommendation degree according to recorded history information of user-watched videos, and taking the to-be-recommended videos as current to-be-recommended videos; selecting a first to-be-recommended video in the current to-be-recommended videos and writing the first to-be-recommended video into a recommendation list according to the recommendation degree; calculating and obtaining user preference satisfaction degree according to a feature vector of the first to-be-recommended video and the user preference parameter; revising the user preference parameter according to the user preference satisfaction degree, and reordering other to-be-recommended videos which are not written into the recommendation list according to the revised user preference parameter; taking the other to-be-recommended videos after reordered which are not written into the recommendation list as the current to-be-recommended videos, returning and continuing to execute the step of selecting the first to-be-recommended video in the current to-be-recommended videos and writing the first to-be-recommended video into the recommendation list according to the recommendation degree, until all the to-be-recommended videos are written into the recommendation list; recommending the to-be-recommended videos in the recommendation list to a user according to the order that the to-be-recommended videos are written into the recommendation list.

According to another aspect of the invention, there is also provided a video recommendation device, comprising: a video obtaining module, configured to obtain multiple to-be-recommended videos sorted by recommendation degree according to recorded history information of user-watched videos, and taking the to-be-recommended videos as current to-be-recommended videos; a user preference parameter calculation module, configured to obtain initial user preference parameter according to the recorded history information of user-watched videos; a recommendation list generation module, configured to select a first to-be-recommended video in the current to-be-recommended videos and writing the first to-be-recommended video into a recommendation list according to the recommendation degree; a user preference satisfaction degree calculation module, configured to calculate and obtain the user preference satisfaction degree according to the feature vector of the first to-be-recommended video and the user preference parameter; a user preference parameter revise module, configured to revise the user preference parameters according to the user preference satisfaction degree; a video sorting module, configured to reorder other to-be-recommended videos which are not written into the recommendation list according to the revised user preference parameter; a returning module, configured to take the other to-be-recommended videos after reordered which are not written into the recommendation list as the current to-be-recommended videos, return and continue to execute the recommendation list generation module, until all the to-be-recommended videos are written into the recommendation list; a video recommendation module, configured to recommend the to-be-recommended videos in the recommendation list to a user according to the order that the to-be-recommended videos are written into the recommendation list.

According to another one aspect of the invention, there is provided a computer program, including computer readable codes, wherein when the computer readable codes are carried out on a computing apparatus, the computing apparatus executes the method for processing the video recommendation method above.

According to another one aspect of the invention, there is provided a computer readable medium, in which the computer program is stored.

According to the video recommendation method and device provided by the invention, in the process of video recommendation, the user preference parameter is revised according to the user preference satisfaction degree obtained by the real-time calculation, and in the circumstance that after recommending a video which meets a user's preference, the user's preference is satisfied to a certain extent, by revising user preference parameter, a new user preference is generated, and then videos meet new user preference may be recommended, thus solving the problem of singleness in the video recommendation.

The above descriptions are merely an overview of technical solutions of the present invention. In order to be able to understand the technical solutions of the present invention more clearly and able to implement according to the content of the descriptions, also in order to make the above and other purposes, features and advantages of the invention more apparent and easy to understand, detailed embodiments of the invention will be provided below.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 schematically shows a flow chart of a video recommendation method according to an embodiment of the invention;

FIG. 2 schematically shows a flow chart of a video recommendation method according to another embodiment of the invention;

FIG. 3 schematically shows a structural block diagram of a video recommendation device according to an embodiment of the invention.

### DESCRIPTION OF THE EMBODIMENTS

Exemplary embodiments of the present disclosure will be described in more detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

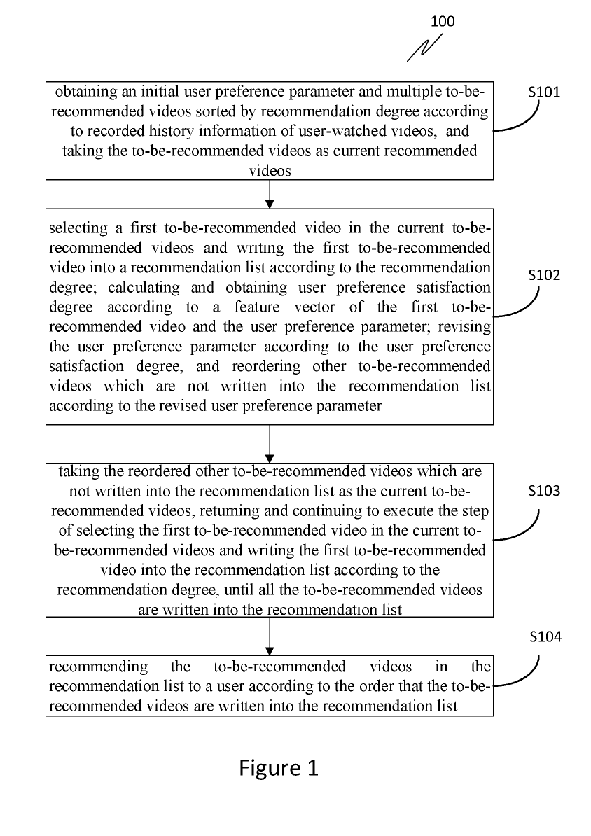

FIG. 1 shows a flow chart of the video recommendation method 100 according to an embodiment of the invention. As shown in FIG. 1, the method 100 begins in step 101, obtaining an initial user preference parameter and multiple to-be-recommended videos sorted by recommendation degree according to recorded history information of user-watched videos, and taking the to-be-recommended videos as current to-be-recommended videos (namely initial current to-be-recommended videos). The recorded history information of user-watched videos reflects users' preferences and interests, therefore, users' interests may be analyzed according to the recorded history information of user-watched videos to obtain an initial user preference parameter, also known as a vector of user interests. In addition, the plurality of to-be-recommended videos may be obtained based on the recorded history information of user-watched videos, and these to-be-recommended videos are sorted according to the order of recommendation degree from high to low. A lot of methods, such as the collaborative filtering method, provided by relevant technologies may be used to obtain N to-be-recommended videos.

Subsequently, the method 100 enters step S102, selecting a first to-be-recommended video in the current to-be-recommended videos and writing the first to-be-recommended video into a recommendation list according to the recommendation degree; calculating and obtaining user preference satisfaction degree according to a feature vector of the first to-be-recommended video and the user preference parameter; revising the user preference parameter according to the user preference satisfaction degree, and reordering other to-be-recommended videos which are not written into the recommendation list according to the revised user preference parameter.

Subsequently, the method 100 enters step S103, taking the other to-be-recommended videos after reordered which are not written into the recommendation list as the current to-be-recommended videos, returning and continuing to execute step S102, until all the to-be-recommended videos are written into the recommendation list.

Obviously, step S102 to step S103 are steps of iterative execution. When all the to-be-recommended videos are written into the recommendation list, the iterative execution finishes.

Subsequently, the method 100 enters step S104, recommending the to-be-recommended videos in the recommendation list to a user according to the order that the to-be-recommended videos are written into the recommendation list.

In the video recommendation method provided by the embodiment of the invention, after obtaining a plurality of to-be-recommended videos sorted by recommendation degree, in the process of video recommendation, the user preference parameter is revised according to the user preference satisfaction degree obtained by the real-time calculation, and in the circumstance that after recommending a video which meets a user's preference, the user's preference is satisfied to a certain extent, by revising the user preference parameter, a new user preference is generated, and then videos meet the new user preference may be recommended. That is to say, the user preference parameters are gradually adjusted with videos being recommended, and hence the order of videos being recommended is adjusted correspondingly, thus well adapting to the change of users' needs during video recommendation.

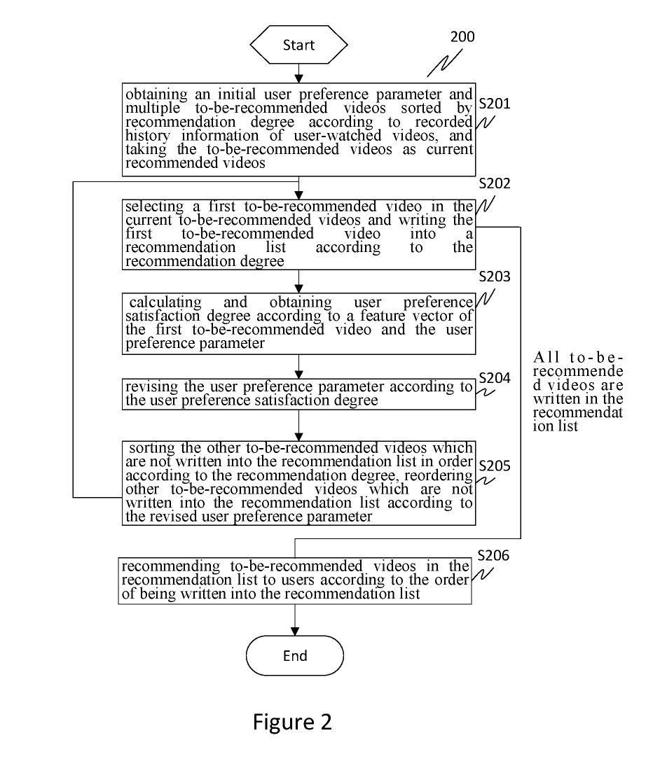

FIG. 2 shows a flow chart of the video recommendation method 200 according to another embodiment of the invention. As shown in FIG. 2, the method 200 begins in step 201, obtaining an initial user preference parameter and multiple to-be-recommended videos sorted by recommendation degree according to recorded history information of user-watched videos, and taking the to-be-recommended videos as current to-be-recommended videos (namely initial current to-be-recommended videos). Specifically, the recorded history information of user-watched videos at least includes video tag content and video tag weight of videos users having watched. For a video, there are one-to-one correspondences between the video tag content and the video tag weight. The video tag content describes the characteristics of the video, and the video tag weight shows the importance of characteristics. Through comparing all video tag weight of a video, it is capable to clearly know the primary characteristic and subordinate characteristic of the video. In this method, the video tag content and the video tag weight are pre-marked, and the video tag content and the video tag weight may be determined through voting and/or scoring by all users having watched the video.

For example, supposing the user has watched the movies “Subway”, “Pirates of the Caribbean: The Curse of the Black Pear”, “The Last Battle”, then the recorded history information of user-watched videos at least includes:

“Subway”. the video tag content: “Luc Besson, Christopher Lambert, Subway, cops and robbers”; the video tag weight: 0.5, 0.2, 0.2, 0.1.

“Pirates of the Caribbean: The Curse of the Black Pear”. the video tag content: “science fiction, European and American, Pirates of the Caribbean: The Curse of the Black Pear, action”; the video tag weight: 0.3, 0.2, 0.3, 0.2.

“The Last Battle”. the video tag content: “Luc Besson, French, science fiction, Jean Reno”; the video tag weight: 0.4, 0.1, 0.2, 0.3.

In this step, based on the recorded history information of user-watched videos, a plurality of to-be-recommended videos may be obtained, and the plurality of to-be-recommended videos are sorted according to the order of recommendation degree from high to low. Methods provided by relevant technologies may be used, such as through the collaborative filtering method, to obtain N to-be-recommended videos, which are represented by “item₁, item₂ . . . itemₙ”. For different methods, what the recommendation degrees in this step refer to are different. For the collaborative filtering recommendation method based on videos, the recommendation degree refers to the similarity degree between videos; for the collaborative filtering recommendation method based on users, the recommendation degree refers to the similarity degree between users. In the examples above, by using the collaborative filtering method, three movies sorted according to the order of recommendation degree from high to low may be obtained: Item1: “The Fifth Element”, Item2: “The Big Blue”, Item3: “Twelve Monkeys”.

In addition, the initial user preference parameter is also obtained based on the recorded history information of user-watched videos. Specifically, according to the video tag content and the video tag weight of videos users watch, the user tag content and the user tag weight are obtained from the recorded history information of user-watched videos, and the vector, which is formed by the user tag weight directed at the user tag content, is taken as the initial user preference parameter and represented by “r(tag₁, tag₂, tag₃ . . . tagₘ)=(t₁, t₂, t₃ . . . tₘ)”,wherein tag₁, tag₂, tag₃ . . . tagₘ are m user tag contents respectively, t₁, t₂, t₃ . . . tₘ are the user tag weight corresponding to m user tag content. The user preference parameter relates to the video tag content and the video tag weight of videos the user watches, at the same time, also relates to the frequency of the user watching some video, the times of the user watching some video recently and other parameters, and the sum of the user tag weight is 1. The user preference parameter reflects what types of videos an user is interested in, the vector above is also called vector of user interests, and a model constructed by the vector of user interests is user's interest model. In the example above, a group of user tag content is obtained according to the information of the three movies that the user has watched: “Luc Besson, science fiction, French, action”, and the corresponding user tag weight: 0.4, 0.3, 0.1, 0.2, that is to say, the initial user preference parameter is r (Luc Besson, science fiction, French, action)=(0.4, 0.3, 0.1, 0.2).

Subsequently, the method 200 enters step S202, selecting a first to-be-recommended video in the current to-be-recommended videos and writing the first to-be-recommended video into a recommendation list according to the recommendation degree. Optionally, take the to-be-recommended video which has the highest recommendation degree in the current to-be-recommended videos as the first to-be-recommended video and write it into the recommendation list. After step S201 is executed and this step is entered, multiple to-be-recommended videos obtained in step S201 are used as current to-be-recommended videos in this step. Since in step S201, the plurality of to-be-recommended videos have been sorted according to the order of recommendation degree from high to low, in this step, the first to-be-recommended video which has the highest recommendation degree is selected and written into the recommendation list. In the example above, “the fifth element” is written into the recommendation list first.

Subsequently, the method 200 enters step S203, calculating and obtaining user preference satisfaction degree according to a feature vector of the first to-be-recommended video and the user preference parameter. The feature vector of the first to-be-recommended video is a vector formed by the video tag weight directed at the video tag content of the first to-be-recommended video, and represented by item_tag(tag₁, tag₂, tag₃ . . . tagₖ)=(s₁, s₂, s₃ . . . sₖ), wherein tag₁, tag₂, tag₃ . . . tagₖ are k video tag content of to-be-recommended videos respectively, s₁, s₂, s₃ . . . sₖ are the video tag weight corresponding to k video tag content of to-be-recommended videos respectively. For n to-be-recommended videos above, the feature vectors of them are expressed as item_tag1, item_tag2, . . . , item_tagn respectively. In the example above, set the video tag content of “The Fifth Element” to: “Luc Besson, science fiction, The Fifth Element, Bruce Willis”, and the corresponding video tag weight: 0.6, 0.2, 0.1, 0.1, then item_tag1 (Luc Besson, science fiction, the fifth element, Bruce Willis)=(0.6, 0.2, 0.1, 0.1); the video tag content of “The Big Blue” is: “Luc Besson, French, The Big Blue, LucBesson, classic”, and the corresponding video tag weight is: 0.6, 0.1, 0.1, 0.1, 0.1, then item_tag2 (Luc Besson, French, The Big Blue, [symbol] , classic)=(0.6, 0.1, 0.1, 0.1, 0.1); the video tag content of “Twelve Monkeys” is: “science fiction, Bruce Willis, Twelve Monkeys, classic”, and the corresponding video tag weight is: 0.4, 0.3, 0.2, 0.1, then item_tag3 (science fiction, Bruce Willis, Twelve Monkeys, classic)=(0.4, 0.3, 0.2, 0.1).

This step further includes: calculating and obtaining similarity degree between the first to-be-recommended video and user's preference according to the feature vector of the first to-be-recommended video and the user preference parameter; then, calculating and obtaining the user preference satisfaction degree according to the feature vector of the first to-be-recommended video and the similarity degree.

Specifically, if having recommended the first to-be-recommended video item' to a user in step S202, then in this step, first calculate the similarity degree between item_{'} and user's preferences according to the feature vector of the first to-be-recommended video item_tag1 and the initial user preference parameter. Make statistical analysis of the video tag content of the first to-be-recommended video and the user tag content in the user preference parameter. For the user tag content corresponding to the user preference parameter is not identical to the video tag content of the first to-be-recommended video item₁, therefore, before calculating the similarity degree, the feature vectors item_tag1 and/or the user preference parameter should be processed for interpolation according to the results of statistical analysis. The interpolation processing includes: corresponding to the corresponding position of the video tag content and/or the user tag content which are not obtained by statistical analysis, inserting preset values correspondingly in the video tag weight in the feature vector of the first to-be-recommended video, and/or, in the user tag weight in the user preference parameter. In the example above, the initial user preference parameter is r (Luc Besson, science fiction, French, action)=(0.4, 0.3, 0.1, 0.2), the feature vector of item₁ “the fifth element” item_tag1 (Luc Besson, science fiction, the fifth element, Bruce Willis)=(0.6, 0.2, 0.1, 0.1). Make a statistics of all the user tag content corresponding to the user preference parameter and all the video tag content of the first to-be-recommended video item₁, and obtain: Luc Besson, science fiction, French, action, the fifth element, Bruce Willis, wherein, there are no “Bruce Willis” and “the fifth element” in the user tag content that the user preference parameter corresponds to, there are no “French” and “action” in the video tag content of the to-be-recommended video item₁ either. In this invention, interpolation processing is to insert preset values in the specific positions of the user preference parameter and the feature vector of the first to-be-recommended video, wherein the specific positions refer to positions of the weight corresponding to the position of the content of tags which is not obtained by statistics, and the preset value is preferably 0. In the example above, after interpolation processing, the user preference parameter is r (Luc Besson, science fiction, French, action, the fifth element, Bruce Willis)=(0.4, 0.3, 0.1, 0.2, 0, 0), and the feature vector of item₁ “the fifth element” item_tag1 (Luc Besson, science fiction, French, action, the fifth element, Bruce Willis)=(0.6, 0.2, 0, 0, 0.1, 0.1). Then, through transpose multiplying the user tag weight in the user preference parameter and the video tag weight in the feature vector of item₁ after interpolation processing, the similarity degree sim_item1 between item₁ and user's preference is obtained, that is, sim_item1=r*item_tag1^{T}. In the example above, the similarity degree between “the fifth element” and user's preferences is 0.3.

After calculating and obtaining the similarity degree sim_item1 between item₁ and user's preference, continue to calculate the user preference satisfaction degree item1_satisfy=sim_item1*item_tag1. That is, the user preference satisfaction degree is the product of the video tag weight in the feature vector of the first to-be-recommended video and the similarity degree after interpolation processing. In the example above, item1 satisfy (Luc Besson, science fiction, French, action, the fifth element, Bruce Willis)=(0.18, 0.06, 0, 0, 0.03, 0.03).

After step S203, the method 200 enters step S204, revising the user preference parameter according to the user preference satisfaction degree. Before revising the user preference parameter, first, the user preference satisfaction degree is processed, and values irrelevant to the user preference parameter therein are removed. In the example above, for there is no “Bruce Willis” and “the fifth element” in the user tag content corresponding to the user preference parameter, therefore, remove the values of the user preference satisfaction degrees corresponding to these two items, and obtain item1 satisfy(Luc Besson, science fiction, French, action)=(0.18, 0.06, 0, 0). Then, obtain the revised user preference parameter by subtracting the processed user preference satisfaction degree from the user preference parameter, that is, r=r-item1_satisfy. In the example above, the revised user preference parameter is r(Luc Besson, science fiction, French, action)=(0.22, 0.24, 0.1, 0.2). Since the sum of the user tag weight is required to be 1, it is also necessary to perform normalization to the revised user preference parameter.

After step S204, the method 200 enters step S205, reordering other to-be-recommended videos which are not written into the recommendation list according to the revised user preference parameter. Specifically, calculate the recommendation degrees of the other to-be-recommended videos which are not written into the recommendation list according to the revised user preference parameter, and sort the other to-be-recommended videos which are not written into the recommendation list according to the recommendation degrees. Optionally, calculating the similarity degree between the other to-be-recommended videos which are not written into the recommendation list and user's preference, taking it as the recommendation degree, and see related descriptions in the step S203 above for the specific methods for calculating. In the example above, from the revised user preference parameter obtained from step S204 it is capable to see that the needs of users for “Luc Besson” are met, thus reducing the preference for “Luc Besson”, while the needs of users for “science fiction” increase relatively. When calculating the recommendation degree according to the revised results, the recommendation degree of “Twelve Monkeys” may be higher than “The Big Blue”. Therefore, the next movie to be recommended to users should be “Twelve Monkeys” instead of “The Big Blue”.

After step S205, taking the other to-be-recommended videos which are not written into the recommendation list after reordering as the current to-be-recommended videos, and the method 200 jumps into step S202, executes step S202 to step S205 mentioned above repeatedly, until n to-be-recommended videos are all written into the recommendation list.

The method 200 enters step S206, recommending to-be-recommended videos in the recommendation list to users according to the order of being written into the recommendation list. The method 200 ends.

According to the methods for video recommendation provided by the embodiments above of the invention, in the process of video recommendation, revise the user preference parameter dynamically according to the user preference satisfaction degree obtained by the real-time calculation, and in the circumstance that after recommending a video which meets a user's preference, the needs of user's being satisfied to a certain extent, by revising user preference parameter, a new user preference is generated, and then recommend videos which meet the new user preference, solving the problem of singleness in the video recommendation. Taking the example above for example, the user like Luc Besson's movies, and according to the user's initial user preference parameter, firstly another movie directed by Luc Besson “the fifth element” is recommended. After “the fifth element” is recommended, it revises the user preference parameter dynamically, and the weight of user's preference for “Luc Besson” decreases, while in the circumstance that the sum of the weight value is 1, the weight of preference for “science fiction” increases relatively. And it is the science fiction movie “Twelve Monkeys” that is continued to be recommended to users. Based on the method of the present embodiment, the user preference parameter will be gradually adjusted with videos being recommended, and hence the order of videos being recommended is adjusted correspondingly, thus well adapting to the change of needs of the user during video recommendations.

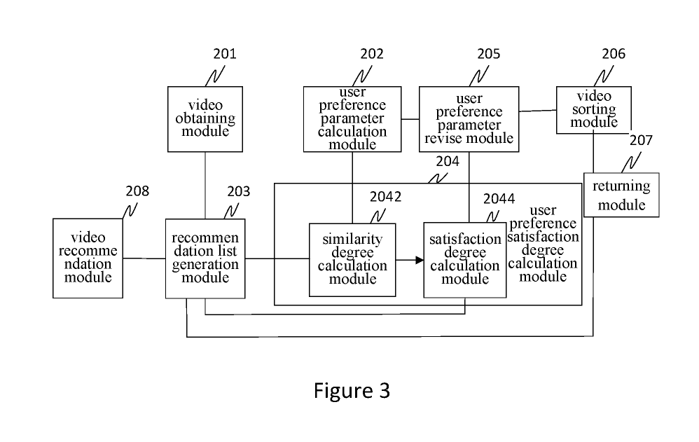

FIG. 3 schematically shows a structural block diagram of a video recommendation device according to an embodiment of the invention. As shown in FIG. 3, the video recommendation device includes: a video obtaining module 201, a user preference parameter calculation module 202, a recommendation list generation module 203, an user preference satisfaction degree calculation module 204, an user preference parameter revise module 205, a video sorting module 206, a returning module 207, and a video recommendation module 208.

The video obtaining module 201 is configured to obtain multiple to-be-recommended videos sorted by recommendation degree according to recorded history information of user-watched videos, and taking the to-be-recommended videos as current to-be-recommended videos (namely, initial current to-be-recommended videos). The recorded history information of user-watched videos includes at least the video tag content and the video tag weight of videos users having watched. For a video, there are one-to-one correspondences between the video tag content and the video tag weight. The video tag content describes the characteristics of the video, and the video tag weight shows the importance of characteristics. Through comparing all video tag weight of a video, it is capable to clearly know the primary characteristic and subordinate characteristic of the video. In this apparatus, the video tag content and the video tag weight are pre-marked, and the video tag content and the video tag weight may be determined through voting and/or scoring by all users having watched the video.

For example, supposing that users have watched the movie “Subway”, “Pirates of the Caribbean: The Curse of the Black Pear” , “The Last Battle” , then the recorded history information of user-watched videos includes at least:

“Subway”. the video tag content: “Luc Besson, Christopher Lambert, Subway, gangster”; the video tag weight: 0.5, 0.2, 0.2, 0.1.

“Pirates of the Caribbean: The Curse of the Black Pear”, the video tag content: “science fiction, European and American, Pirates of the Caribbean: The Curse of the Black Pear, action”; the video tag weight: 0.3, 0.2, 0.3, 0.2.

“The Last Battle”. the video tag content: “Luc Besson, French, science fiction, Jean Reno”; the video tag weight: 0.4, 0.1, 0.2, 0.3.

The video obtaining module 201 is able to obtain multiple to-be-recommended videos based on the recorded history information of user-watched videos, and these pluralities of to-be-recommended videos are sorted according to the recommendation degree. A lot of methods are provided by relevant technologies. Optionally, the video obtaining module 201 is configured to according to the collaborative filtering method, obtain multiple to-be-recommended videos which are sorted according to the recommendation degree. It should be noted that for different methods, what the recommendation degrees refer to are different. For the collaborative filtering recommendation method based on videos, the recommendation degree refers to the similarity degree between videos; for the collaborative filtering recommendation method based on users, the recommendation degree refers to the similarity degree between users. In the example above, by using the collaborative filtering method, the video obtaining module 201 is able to obtain three movies sorted according to the order of recommendation degree from high to low: Item1: “the fifth element”, Item2: “The Big Blue”, Item3: “Twelve Monkeys”.

The user preference parameter calculation module 202 is configured to obtaining initial user preference parameter according to the recorded history information of user-watched videos. The initial user preference parameter is also obtained based on the recorded history information of user-watched videos. Specifically, according to the video tag content and the video tag weight of videos users watch, the user tag content and the user tag weight are obtained from the recorded history information of user-watched videos, and the vector, which is formed by the user tag weight directed at the user tag content, is taken as the initial user preference parameter and represented by r(tag₁, tag₂, tag₃ . . . tagₘ)=t₁, t₂, t₃ . . . tₘ), wherein tag₁, tag₂, tag₃ . . . tagₘ are m user tag content respectively, t₁, t₂, t₃ . . . tₘ are the user tag weight corresponding to m user tag content. The user preference parameter relates to the video tag content and the video tag weight of videos user watch, at the same time, also relates to the frequency of the user watching some video, the times of the user watching some video recently and other parameters, and the sum of the user tag weight is 1. In the example above, according to the information of the three movies that users have watched, a group of user tag content: “Luc Besson, science fiction, French, action”, and the corresponding user tag weight: 0.4, 0.3, 0.1, 0.2, are obtained, that is, initial user preference parameter is r(Luc Besson, science fiction, French, action)=(0.4, 0.3, 0.1, 0.2).

The recommendation list generation module 203 is configured to select a first to-be-recommended video in the current to-be-recommended videos and write the first to-be-recommended video into a recommendation list according to the recommendation degree. Specifically, the recommendation list generation module 203 is configured to take the to-be-recommended video which has the highest recommendation degree in the current to-be-recommended videos as the first to-be-recommended video and write it into the recommendation list. Multiple to-be-recommended videos, which are obtained through the video obtaining module 201, are taken as the initial current to-be-recommended videos in this module. Because the plurality of to-be-recommended videos which are obtained in the video obtaining module 201 have been sorted according to the order of recommendation degree, the recommendation list generation module 203 selects the first to-be-recommended video which has the highest recommendation degree and writes it into the recommendation list. In the example above, firstly write “the fifth element” into the recommendation list.

The user preference satisfaction degree calculation module 204 is configured to calculate and obtain the user preference satisfaction degree according to the feature vector of the first to-be-recommended video and the user preference parameter. The feature vector of the to-be-recommended video is a vector formed by the video tag weight directed at the video tag content of the to-be-recommended video, and represented by item_tag(tag₁, tag₂, tag₃ . . . tag k)=(s₁, s₂, s₃ . . . sₖ), wherein tag₁, tag₂, tag₃ . . . tag ₖ are k video tag content of to-be-recommended videos respectively, S₁, s₂, s₃ . . . sₖ are the video tag weight that k video tag content of to-be-recommended videos correspond to respectively. For n to-be-recommended videos above, the feature vectors of them are represented as item_tag1, item_tag2, . . . , item_tagn respectively. In the example above, set the video tag content of “the fifth element” to: “Luc Besson, science fiction, the fifth element, Bruce Willis”, and the corresponding video tag weight: 0.6, 0.2, 0.1, 0.1, then item_tag₁ (Luc Besson, science fiction, the fifth element, Bruce Willis)=(0.6, 0.2, 0.1, 0.1); the video tag content of “The Big Blue” is: “Luc Besson, French, The Big Blue, [symbol] , classic”, and the corresponding video tag weight are: 0.6, 0.1, 0.1, 0.1, 0.1, then item_tag2 (Luc Besson, French, The Big Blue, [symbol] , classic)=(0.6, 0.1, 0.1, 0.1, 0.1); the video tag content of “Twelve Monkeys” is: “science fiction, Bruce Willis, Twelve Monkeys, classic”, and the corresponding video tag weight is: 0.4, 0.3, 0.2, 0.1, then item_tag3 (science fiction, Bruce Willis, Twelve Monkeys, classic)=(0.4, 0.3, 0.2, 0.1).

Further, the user preference satisfaction degree calculation module 204 includes: a similarity degree calculation module 2042 and a satisfaction degree calculation module 2044. The similarity degree calculation module 2042 is configured to calculate and obtain similarity degree between the first to-be-recommended video and user's preference according to the feature vector of the first to-be-recommended video and the user preference parameter; the satisfaction degree calculation module 2044 is configured to calculate and obtain the user preference satisfaction degree according to the feature vector of the first to-be-recommended video and the similarity degree.

Specifically, if the recommendation list generation module 203 recommends the first to-be-recommended video item₁ to users, then the similarity degree calculation module 2042 first makes statistical analysis of the video tag content of the first to-be-recommended video and the user tag content in the user preference parameter, and the feature vector of the first to-be-recommended video and/or the user preference parameter are processed for interpolation according to the results of statistical analysis respectively. The interpolation processing includes: corresponding to the corresponding position of the video tag content and/or the user tag content which are not obtained statistical analysis, inserting preset values correspondingly in the video tag weight in the feature vector of the first to-be-recommended video, and/or, in the user tag weight in the user preference parameter; transpose multiplying the user tag weight in the user preference parameter and the video tag weight in the feature vector of the first to-be-recommended video after interpolation processing, and obtaining the similarity degree. Specifically, the similarity degree sim_item1 between item₁ and user's preference is calculated according to the feature vector of item₁ item_tag1 and the initial user preference parameter. For the user tag content corresponding to the user preference parameter is not identical to the video tag content of the first to-be-recommended video item_{'}, therefore, before calculating the similarity degree, the feature vector item_tag₁ and/or the user preference parameter should be processed for interpolation. In the example above, the initial user preference parameter is r (Luc Besson, science fiction, French, action)=(0.4, 0.3, 0.1, 0.2), the feature vectors of item' “the fifth element” item_tag₁ (Luc Besson, science fiction, the fifth element, Bruce Willis)=(0.6, 0.2, 0.1, 0.1). Make a statistics of all the user tag content corresponding to the user preference parameter and all the video tag content of the first to-be-recommended video item₁, and obtain: Luc Besson, science fiction, French, action, the fifth element, Bruce Willis, wherein, there is no “Bruce Willis” and “the fifth element” in the user tag content corresponding to the user preference parameter, there is no “French” and “action” in the video tag content of the first to-be-recommended video item₁ either. In this invention, interpolation processing is to insert preset values in the specific positions of the user preference parameter and the feature vector of the first to-be-recommended video, wherein the specific positions refer to positions of the weight corresponding to the position of the content of tags is not obtained by statistics, and the preset value is preferably 0. In the example above, after interpolation processing, the user preference parameter is r (Luc Besson, science fiction, French, action, the fifth element, Bruce Willis)=(0.4, 0.3, 0.1, 0.2, 0, 0), and the feature vector of item_{'} “the fifth element” is item_tag₁ (Luc Besson, science fiction, French, action, the fifth element, Bruce Willis)=(0.6, 0.2, 0, 0, 0.1, 0.1). Then, through the transpose multiplying of the user tag weight in the user preference parameter and the video tag weight in the feature vector of item₁ after interpolation processing, the similarity degree sim_item1 between item₁ and user's preference is obtained, that is, sim_item1=r*item_tag1^{T}. In the example above, the similarity degree between “the fifth element” and user's preference is 0.3.

After calculating and obtaining the similarity degree sim_item1 between item₁ and user's preference, the satisfaction degree calculation module 2044 continues to calculate the user preference satisfaction degree item1_satisfy=sim_item1*item_tag1. That is, the video tag weight in the feature vector of the first to-be-recommended video and the similarity degree after interpolation processing are multiplied to obtain the user preference satisfaction degree. In the example above, item1_satisfy (Luc Besson, science fiction, French, action, the fifth element, Bruce Willis)=(0.18, 0.06, 0, 0, 0.03, 0.03).

The user preference parameter revise module 205 is configured to revise the user preference parameter according to the user preference satisfaction degree. Before revising the user preference parameter, firstly, the user preference satisfaction degree is processed, and values irrelevant to the user preference parameter therein are removed. In the example above, for there is no “Bruce Willis” and “the fifth element” in the user tag content corresponding to the user preference parameter, therefore, the values of the user preference satisfaction degree corresponding to these two items are removed, and obtain item1_satisfy (Luc Besson, science fiction, French, action)=(0.18, 0.06, 0, 0). Then, obtain the revised user preference parameter by subtracting the user preference satisfaction degree after processing from the user preference parameter, that is, r=r−item1_satisfy. In the example above, the revised user preference parameter is r (Luc Besson, science fiction, French, action)=(0.22, 0.24, 0.1, 0.2). Because the sum of the user tag weight is required to be 1, therefore, it is also necessary to make normalized processing of the revised user preference parameter.

The video sorting module 206 is configured to reorder other to-be-recommended videos which are not written into the recommendation list according to the revised user preference parameter. Specifically, according to the revised user preference parameter, calculate the recommendation degrees of the other to-be-recommended videos which are not written into the recommendation list, and sort the other to-be-recommended videos which are not written into the recommendation list according to the recommendation degree. Optionally, calculate the similarity degree between the other to-be-recommended videos which are not written into the recommendation list and user's preference, take it as the recommendation degree, and see related descriptions in the similarity degree calculation module 2042 above for the specific methods for calculating. In the example above, from the revised user preference parameter obtained by using user preference parameter revise module 205, it is capable to see that the needs of users for “Luc Besson” are met, thus reducing the preference for “Luc Besson”, while the needs of users for “science fiction” increase relatively. When calculating the recommendation degree according to the revised results, the recommendation degree of “Twelve Monkeys” will be higher than “The Big Blue”. Therefore, the next movie to be recommended to users should be “Twelve Monkeys” instead of “The Big Blue”.

The returning module 207 is configured to take the other videos to-be-recommended which are not written into the recommendation list after reordering as the current to-be-recommended videos, return the recommendation list generation module 203 and continue to execute it until all the other videos to-be-recommended which are not written into the recommendation list have been written into the recommendation list.

The video recommendation module 208 is configured to recommend the to-be-recommended videos in the recommendation list to a user according to the order that the to-be-recommended videos are written into the recommendation list after all the plurality of videos to-be-recommended are written into the recommendation list by the recommendation list generation module 203.

According to the video recommendation device provided by the embodiments above of the invention, in the process of video recommendation, revise the user preference parameter dynamically according to the user preference satisfaction degree obtained by the real-time calculation, and in the circumstance that after recommending a video which meets a user's preferences, the needs of user's preferences are satisfied to a certain extent, by revising user preference parameters, a new user preference is generated, and then recommend videos which meet the new user preference, solving the problem of singleness in the video recommendation. Taking the examples above for example, a user likes Luc Besson's movies, and according to the user's initial user preference parameter, it first recommends another movie directed by Luc Besson “the fifth element”. After “the fifth element” being recommended, it revises the user preference parameter dynamically, and the weight of user's preference for “Luc Besson” decreases, while in the circumstance that the sum of the weight value is 1, the weight of preference for “science fiction” increases relatively. And it is the science fiction movie “Twelve Monkeys” that is continued to recommend to users. Based on the device of the present embodiment, the user preference parameter will be gradually adjusted with videos being recommended, and hence the order of videos being recommended will be adjusted correspondingly, thus well adapting to the change of needs of users during video recommendations.

According to the device stated in the embodiments of the invention, the similarity degree calculation module 2042 is further configured to: make statistical analysis of the video tag content of the first to-be-recommended video and the user tag content in the user preference parameter, perform interpolation processing to the feature vector of the first to-be-recommended video and/or the user preference parameter according to the results of statistical analysis respectively, wherein, the interpolation processing includes: corresponding to the corresponding position of the video tag content and/or the user tag content which are not obtained by statistical analysis, inserting preset values correspondingly in the video tag weight in the feature vector of the first to-be-recommended video, and/or, in the user tag weight in the user preference parameter; transpose multiply the user tag weight in the user preference parameter and the video tag weight in the feature vector of the first to-be-recommended video after interpolation processing, and obtain the similarity degree.

According to the device stated in the embodiments of the invention, the satisfaction degree calculation module 2044 is further configured to: multiply the interpolation-processed video tag weight in the feature vector of the first to-be-recommended video and the similarity degree to obtain the user preference satisfaction degree.

According to the device stated in the embodiments of the invention, the user preference parameter revise module is further configured to: process the user preference satisfaction degree, and remove values in the user preference satisfaction degree which are irrelevant to the user preference parameter; and obtain the revised user preference parameter by subtracting the processed user preference satisfaction degree from the user preference parameter.

According to the device stated in the embodiments of the invention, the video sorting module is further configured to: calculate the recommendation degrees of the other to-be-recommended videos which are not written into the recommendation list according to the revised user preference parameter, and sort the other to-be-recommended videos which are not written into the recommendation list according to the recommendation degree.

The invention also provides a computer readable recording medium on which programs for performing the aforementioned video recommendation method are recorded. The computer readable recording medium includes any mechanism for storing or transmitting information in computer-readable forms. For example, the machine readable media include read-only memories (ROM), random access memories (RAM), disk storage media, light storage media, flash storage media, electricity, light, sounds, or other forms of propagation signals (for example, carrier wave, infrared signals, digital signals, etc.), and so on.

The algorithms and displays provided herein are not inherently related to any particular computer, virtual system, or other devices. A variety of general-purpose systems may be used together with the teachings based on this. According to the descriptions above, it is obvious to construct the structure required by systems of this sort is obvious. In addition, the invention is not directed at any particular programming language either. It should be understood that it is capable to use a variety of programming languages to achieve the content of the invention described herein, and the descriptions of the specific language above are in order to disclose the best mode for carrying out the present invention.

In the instructions provided herein, numerous specific details are illustrated. However, it is understood that it is capable to carry out the embodiments of the invention in the circumstance without these specific details. In some examples, well-known methods, structures, and techniques are not shown in detail so as not to obscure the understanding of the present instructions.

Similarly, it should be understood that in order to streamline the present publicity and help to understand one aspect or more aspects in various aspects of the invention, in the descriptions of exemplary embodiments of the invention above, sometimes various features of the invention are grouped into a single embodiment, chart, or the description of it together. However, it should not to explain the disclosed methods reflecting the following intentions: that is, the present invention demanding protection demands more characteristics than those documented definitely in each of the claims. More precisely, as reflected in the claims below, inventive aspects lie in technical features less than all features of single foregoing disclosed embodiments illustrated above. Therefore, the claims which follow the specific implementations are thus incorporated into the specific implementation definitely, wherein each of the claims itself is as a separate embodiment of the present invention.

The skilled person in the art may understand that it is capable to make the modules in the devices in the embodiment have changes adaptively and set them into one device or more devices which are different from the present embodiment. It is capable to combine the module or unit or component in the embodiments into one module or unit or component, and besides, it is capable to divide them into multiple sub-modules or sub-units or sub-components. Besides that at least some in such features and/or processes or units are mutually exclusive, it is capable to use any combination to make the combination of all the disclosed features and all the processes or units of any method or device disclosed in this way in the present invention(including the accompanying claims, abstracts and attached drawings). Unless otherwise explicitly stated, it is capable to replace each feature disclosed in the present invention(including the accompanying claims, abstracts and attached drawings) with the alternative features which provide the same, equal or similar purpose.

In addition, the skilled person in the art are able to understand that although some embodiments stated herein include some features rather than other features included in other embodiments, the combinations of features of different embodiments mean to be in within the scope of the invention and form different embodiments. For example, in the following claims, it is capable to use any one of the embodiments in demanding protection in combination of any way.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the device for webpage zooming on an electronic apparatus according to the embodiments of the disclosure. The disclosure may further be implemented as equipment or device programs (for example, computer programs and computer program products) for executing some or all of the methods as described herein. The programs for implementing the disclosure may be stored in the computer readable medium, or have a form of one or more signal. Such a signal may be downloaded from the internet websites, or be provided in carrier, or be provided in other manners.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

1. A video recommendation method, comprising:
obtaining an initial user preference parameter and multiple to-be-recommended videos sorted by recommendation degree according to recorded history information of user-watched videos, and taking the to-be-recommended videos as current to-be-recommended videos;
selecting a first to-be-recommended video in the current to-be-recommended videos and writing the first to-be-recommended video into a recommendation list according to the recommendation degree; calculating and obtaining user preference satisfaction degree according to a feature vector of the first to-be-recommended video and the user preference parameter; revising the user preference parameter according to the user preference satisfaction degree, and reordering other to-be-recommended videos which are not written into the recommendation list according to the revised user preference parameter;
taking the other to-be-recommended videos after reordered which are not written into the recommendation list as the current to-be-recommended videos, returning and continuing to execute the step of selecting the first to-be-recommended video in the current to-be-recommended videos and writing the first to-be-recommended video into the recommendation list according to the recommendation degree, until all the to-be-recommended videos are written into the recommendation list;
recommending the to-be-recommended videos in the recommendation list to a user according to the order that the to-be-recommended videos are written into the recommendation list.

2. The method according to claim 1, wherein, the recorded history information of user-watched videos comprises video tag content and video tag weight of videos users having watched;
obtaining the initial user preference parameter according to the recorded history information of user-watched videos comprises: obtaining user tag content and user tag weight from the recorded history information of user-watched videos according to the video tag content and the video tag weight of videos users having watched, taking a vector formed by the user tag weight directed at the user tag content as the initial user preference parameter.

3. The method according to claim 2, wherein, the feature vector of the first to-be-recommended video is a vector formed by the video tag weight which is directed at the video tag content of the first to-be-recommended video;
calculating and obtaining the user preference satisfaction degree according to the feature vector of the first to-be-recommended video and the user preference parameter includes:
calculating and obtaining similarity degree between the first to-be-recommended video and user's preference according to the feature vector of the first to-be-recommended video and the user preference parameter;
calculating and obtaining the user preference satisfaction degree according to the feature vector of the first to-be-recommended video and the similarity degree.

4. The method according to claim 3, wherein, calculating and obtaining the similarity degree between the first to-be-recommended video and user's preference according to the feature vector of the first to-be-recommended video and the user preference parameter includes:
making statistical analysis of the video tag content of the first to-be-recommended video and the user tag content in the user preference parameter, performing interpolation processing to the feature vector of the first to-be-recommended video and/or the user preference parameter according to the results of statistical analysis respectively, wherein, the interpolation processing includes: corresponding to the corresponding position of the video tag content and/or the user tag content which are not obtained by statistical analysis, inserting preset values correspondingly in the video tag weight in the feature vector of the first to-be-recommended video, and/or, in the user tag weight in the user preference parameter;
transpose multiplying the user tag weight in the user preference parameter and the video tag weight in the feature vector of the first to-be-recommended video after interpolation processing, and obtaining the similarity degree.

5. The method according to claim 4, wherein, calculating and obtaining the user preference satisfaction degree according to the feature vector of the first to-be-recommended video and the similarity degree comprises:
multiplying the interpolation-processed video tag weight in the feature vector of the first to-be-recommended video and the similarity degree to obtain the user preference satisfaction degree.

6. The method according to claim 5, wherein, revising the user preference parameter according to the user preference satisfaction degree comprises:
processing the user preference satisfaction degree, and removing values in the user preference satisfaction degree which are irrelevant to the user preference parameter;
obtaining the revised user preference parameter by subtracting the processed user preference satisfaction degree from the user preference parameter.

7. The method according to claim 1, wherein, reordering other to-be-recommended videos which are not written into the recommendation list according to the revised user preference parameter comprises:
calculating the recommendation degrees of the other to-be-recommended videos which are not written into the recommendation list according to the revised user preference parameter, and sorting the other to-be-recommended videos which are not written into the recommendation list according to the recommendation degree.

8. A computing apparatus for video recommendation, comprising:
a memory having instructions stored thereon;
a processor configured to execute the instructions to perform operations for video recommendation, comprising:
obtaining multiple to-be-recommended videos sorted by recommendation degree according to recorded history information of user-watched videos, and taking the to-be-recommended videos as current to-be-recommended videos;
obtaining initial user preference parameter according to the recorded history information of user-watched videos;
selecting a first to-be-recommended video in the current to-be-recommended videos and writing the first to-be-recommended video into a recommendation list according to the recommendation degree;
calculating, and obtaining the user preference satisfaction degree according to the feature vector of the first to-be-recommended video and the user preference parameter;
revising the user preference parameters according to the user preference satisfaction degree;
reordering other to-be-recommended videos which are not written into the recommendation list according to the revised user preference parameter;
taking the other to-be-recommended videos after reordered which are not written into the recommendation list as the current to-be-recommended videos, returning and continuing to execute selecting the first to-be-recommended video in the current to-be-recommended videos and writing the first to-be-recommended video into the recommendation list according to the recommendation degree, until all the to-be-recommended videos which are not written into the recommendation list are written into the recommendation list;
recommending the to-be-recommended videos in the recommendation list to a user according to the order that the to-be-recommended videos are written into the recommendation list after all the to-be-recommended videos are written into the recommendation list.

9. The computing apparatus according to claim 8, wherein, the recorded history information of user-watched videos comprises video tag content and video tag weight of videos users having watched;
obtaining initial user preference parameter according to the recorded history information of user-watched videos comprises:
obtaining user tag content and user tag weight from the recorded history information of user-watched videos according to the video tag content and the video tag weight of videos users having watched, taking vector formed by the user tag weight directed at the user tag content as the initial user preference parameter.

10. The computing apparatus according to claim 9, wherein, the feature vector of the first to-be-recommended video is a vector formed by the video tag weight which is directed at the video tag content of the first to-be-recommended video;
calculating and obtaining the user preference satisfaction degree according to the feature vector of the first to-be-recommended video and the user preference parameter comprises:
calculate calculating and obtaining similarity degree between the first to-be-recommended video and user's preference according to the feature vector of the first to-be-recommended video and the user preference parameter;
calculating and obtaining the user preference satisfaction degree according to the feature vector of the first to-be-recommended video and the similarity degree.

11. The computing apparatus according to claim 10, wherein, calculating and obtaining similarity degree between the first to-be-recommended video and user's preference according to the feature vector of the first to-be-recommended video and the user preference parameter comprises:
making statistical analysis of the video tag content of the first to-be-recommended video and the user tag content in the user preference parameter, performing interpolation processing to the feature vector of the first to-be-recommended video and/or the user preference parameter according to the results of statistical analysis respectively, wherein, the interpolation processing includes: corresponding to the corresponding position of the video tag content and/or the user tag content which are not obtained by statistical analysis, inserting preset values correspondingly in the video tag weight in the feature vector of the first to-be-recommended video, and/or, in the user tag weight in the user preference parameter; transpose multiplying the user tag weight in the user preference parameter and the video tag weight in the feature vector of the first to-be-recommended video after interpolation processing, and obtaining the similarity degree.

12. The computing apparatus according to claim 11, wherein, calculating and obtaining the user preference satisfaction degree according to the feature vector of the first to-be-recommended video and the similarity degree comprises:
multiplying the interpolation-processed video tag weight in the feature vector of the first to-be-recommended video and the similarity degree to obtain the user preference satisfaction degree.

13. The computing apparatus according to claim 12, wherein, revising the user preference parameters according to the user preference satisfaction degree comprises:
processing the user preference satisfaction degree, and removing values in the user preference satisfaction degree which are irrelevant to the user preference parameter; and obtaining the revised user preference parameter by subtracting the processed user preference satisfaction degree from the user preference parameter.

14. The computing apparatus according to claim 8, wherein, reordering other to-be-recommended videos which are not written into the recommendation list according to the revised user preference parameter comprises:
calculating the recommendation degrees of the other to-be-recommended videos which are not written into the recommendation list according to the revised user preference parameter, and sorting the other to-be-recommended videos which are not written into the recommendation list according to the recommendation degree.

15. (canceled)

16. A non-transitory computer readable medium, having computer program stored thereon that, when executed by one or more processors of a computing apparatus. cause the computing apparatus to perform:
obtaining an initial user preference parameter and multiple to-be-recommended videos sorted by recommendation degree according to recorded history information of user-watched videos, and taking the to-be-recommended videos as current to-be-recommended videos;
selecting a first to-be-recommended video in the current to-be-recommended videos and writing the first to-be-recommended video into a recommendation list according to the recommendation degree; calculating and obtaining user preference satisfaction degree according to a feature vector of the first to-be-recommended video and the user preference parameter; revising the user preference parameter according to the user preference satisfaction degree, and reordering other to-be-recommended videos which are not written into the recommendation list according to the revised user preference parameter;
taking the other to-be-recommended videos after reordered which are not written into the recommendation list as the current to-be-recommended videos, returning and continuing to execute the step of selecting the first to-be-recommended video in the current to-be-recommended videos and writing the first to-be-recommended video into the recommendation list according to the recommendation degree, until all the to-be-recommended videos are written into the recommendation list;
recommending the to-be-recommended videos in the recommendation list to a user according to the order that the to-be-recommended videos are written into the recommendation list.
